(19) United States
(12) Patent Application Publication
(10) Pub. No.: US 2014/0064971 A1
(43) Pub. Date: Mar. 6, 2014

(54) STIFFENER PLATE FOR A WIND TURBINE

(71) Applicants: Mohan Muthu Kumar Sivanantham, Bangalore (IN); Suresh S. Tirumalai, Simpsonville, SC (US); Gitesh Verma, Bangalore (IN); Giridhar Ron, Bangalore (IN)

(72) Inventors: Mohan Muthu Kumar Sivanantham, Bangalore (IN); Suresh S. Tirumalai, Simpsonville, SC (US); Gitesh Verma, Bangalore (IN); Giridhar Ron, Bangalore (IN)

(73) Assignee: GENERAL ELECTRIC COMPANY, Schenectady, NY (US)

(21) Appl. No.: 13/597,903

(22) Filed: Aug. 29, 2012

(51) Int. Cl. F03D 11/00; F03D 1/06

(52) U.S. Cl. 416/204 R

(57) ABSTRACT

In one aspect, a stiffener plate for coupling a rotor blade to a hub of a wind turbine is disclosed. The stiffener plate may generally include a mounting flange configured to be coupled to at least one of the rotor blade or the hub. The mounting flange may define an inner perimeter and a center point. In addition, the stiffener plate may include a web extending from the inner perimeter towards the center point. The web may define a cross-sectional width that varies between the inner perimeter and the center point.

### FIELD OF THE INVENTION

The present subject matter relates generally to wind turbines and, more particularly, to a stiffener plate for coupling a rotor blade to a wind turbine hub.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, rotor hub and one or more rotor blades. The rotor blades capture kinetic energy from the wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. For example, one such modification has been to increase the rotor diameter of wind turbines. In addition, design efforts have looked to reduce the weight of the up-tower components of wind turbines. For example, it has been proposed to reduce the wall thickness of the hub in order to reduce the overall weight of a wind turbine. However, such a reduction in wall thickness typically leads to reduced strength and stiffness. Since the hub is constantly subjected to various loads during wind turbine operation, this reduced stiffness and strength can lead to deformation of the hub, such as ovalization or out-of-roundness.

Accordingly, a stiffener plate that can be used to increase the rotor diameter of a wind turbine as well as increase the stiffness of the hub would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a stiffener plate for coupling a rotor blade to a hub of a wind turbine. The stiffener plate may generally include a mounting flange configured to be coupled to at least one of the rotor blade or the hub. The mounting flange may define an inner perimeter and a center point. In addition, the stiffener plate may include a web extending from the inner perimeter towards the center point. The web may define a cross-sectional width that varies between the inner perimeter and the center point.

In another aspect, the present subject matter is directed to a stiffener plate for coupling a rotor blade to a hub of a wind turbine. The stiffener plate may generally include a mounting flange configured to be coupled to at least one of the rotor blade or the hub. The mounting flange may define an inner perimeter and a center point. In addition, the stiffener plate may include a web extending from the inner perimeter towards the center point. The web may define a plurality of pitch drive openings. Each of the pitch drive openings may be configured to receive at least a portion of a pitch drive of the wind turbine.

In a further aspect, the present subject matter is directed to a wind turbine. The wind turbine may generally include a rotor having a hub and at least one rotor blade extending outwardly from the hub. The wind turbine may also include a pitch bearing coupled between the hub and the rotor blade. In addition, the wind turbine may include a stiffener plate. The stiffener plate may generally include a mounting flange configured to be coupled between the pitch bearing and the hub or between the pitch bearing and the rotor blade. The mounting flange may define an inner perimeter and a center point. The stiffener plate may also include a web extending from the inner perimeter towards the center point. Moreover, the stiffener plate may include a locking device mounted to the web. The locking device may be configured to engage the pitch bearing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a wind turbine;

FIG. 2 illustrates a partially exploded, perspective view of one embodiment of a hub assembly in accordance with aspects of the present subject matter;

FIG. 3 illustrates a front view of a stiffener plate of the hub assembly shown in FIG. 2;

FIG. 4 illustrates a partial, cross-sectional view of the stiffener plate shown in FIG. 3 taken about line 4-4, particularly illustrating a tapered cross-sectional profile of a stiffening web of the stiffener plate;

FIG. 5 illustrates a front view of another embodiment of a stiffener plate that may be utilized with the hub assembly shown in FIG. 2, particularly illustrating a variation of the configuration of a stiffening web of the stiffener plate;

FIG. 6 illustrates a partial, cross-sectional view of a further embodiment of a stiffener plate that may be utilized with the hub assembly shown in FIG. 2, particularly illustrating a stepped cross-sectional profile of a stiffening web of the stiffener plate:

FIG. 7 illustrates a front view of yet another embodiment of a stiffener plate that may be utilized with the hub assembly shown in FIG. 2, particularly illustrating a plurality of pitch drive openings defined in a stiffening web of the stiffener plate; and,

FIG. 8 illustrates a partial, perspective view of a further embodiment of a stiffener plate that may be utilized with the hub assembly shown in FIG. 2, particularly illustrating a locking device that may be mounted to the stiffener plate so as to engage a pitch bearing of the wind turbine.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to stiffener plates for a wind turbine. In several embodiments, each stiffener plate may include a stiffening web configured to provide increased stiffness and/or strength to the hub. For example, each stiffening web may serve as a structural, cross-member at the hub/blade interface for increasing the overall stiffness of the hub, thereby preventing hub ovalization. In addition, because the stiffener plates are configured to be mounted between the hub and the rotor blades, each stiffener plate may be used to increase the rotor diameter of the wind turbine, thereby enhancing its wind-capturing capabilities.

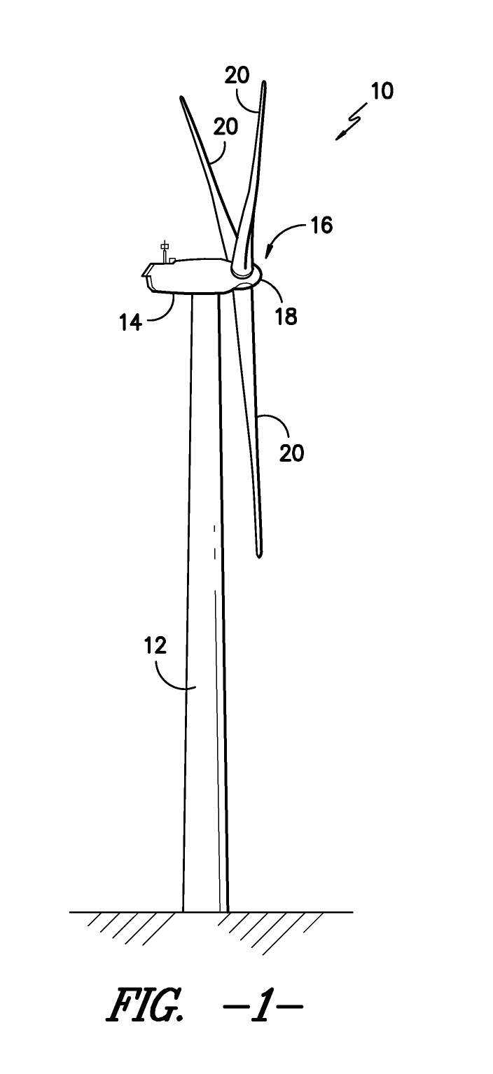

Referring now to the drawings, FIG. 1 illustrates a side view of one embodiment of a wind turbine 10. As shown, the wind turbine 10 generally includes a tower 12, a nacelle 14 mounted on the tower 12, and a rotor 16 coupled to the nacelle 14. The rotor 16 includes a rotatable hub 18 and at least one rotor blade 20 coupled to and extending outwardly from the hub 18. For example, in the illustrated embodiment, the rotor 16 includes three rotor blades 20. However, in an alternative embodiment, the rotor 16 may include more or less than three rotor blades 20. Each rotor blade 20 may be spaced about the hub 18 to facilitate rotating the rotor 16 to enable kinetic energy to be transferred from the wind into usable mechanical energy, and subsequently, electrical energy. For instance, the hub 18 may be rotatably coupled to an electric generator (not shown) positioned within the nacelle 14 to permit electrical energy to be produced.

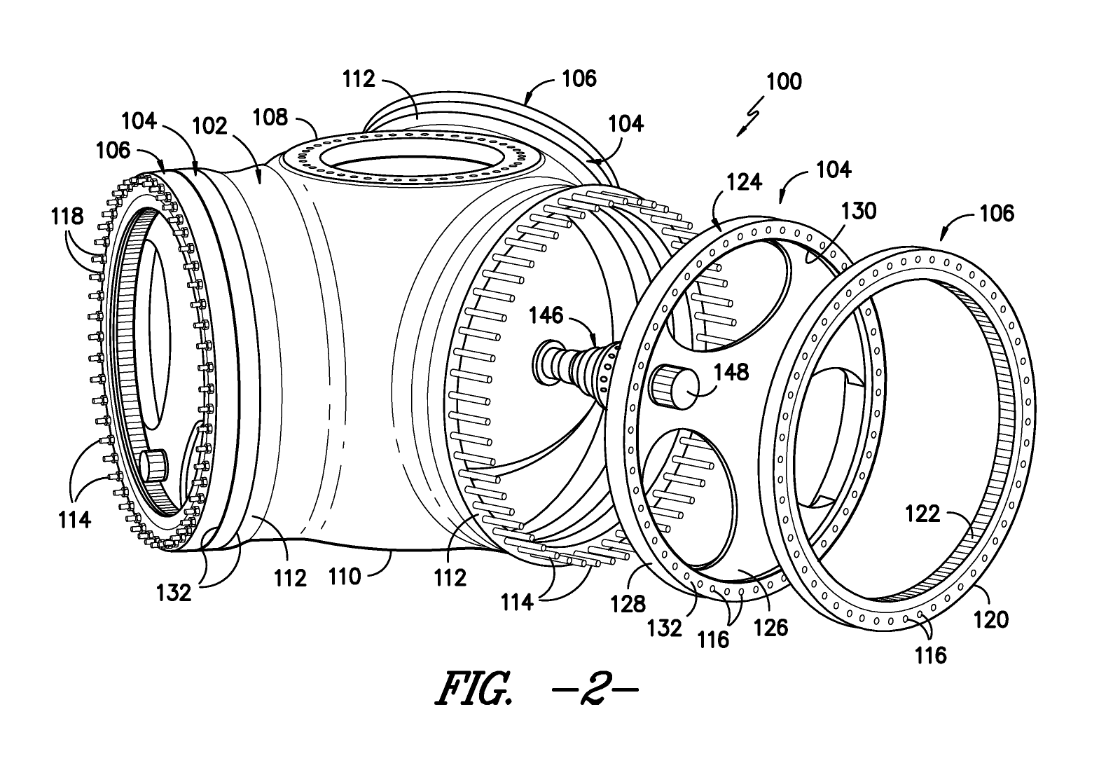

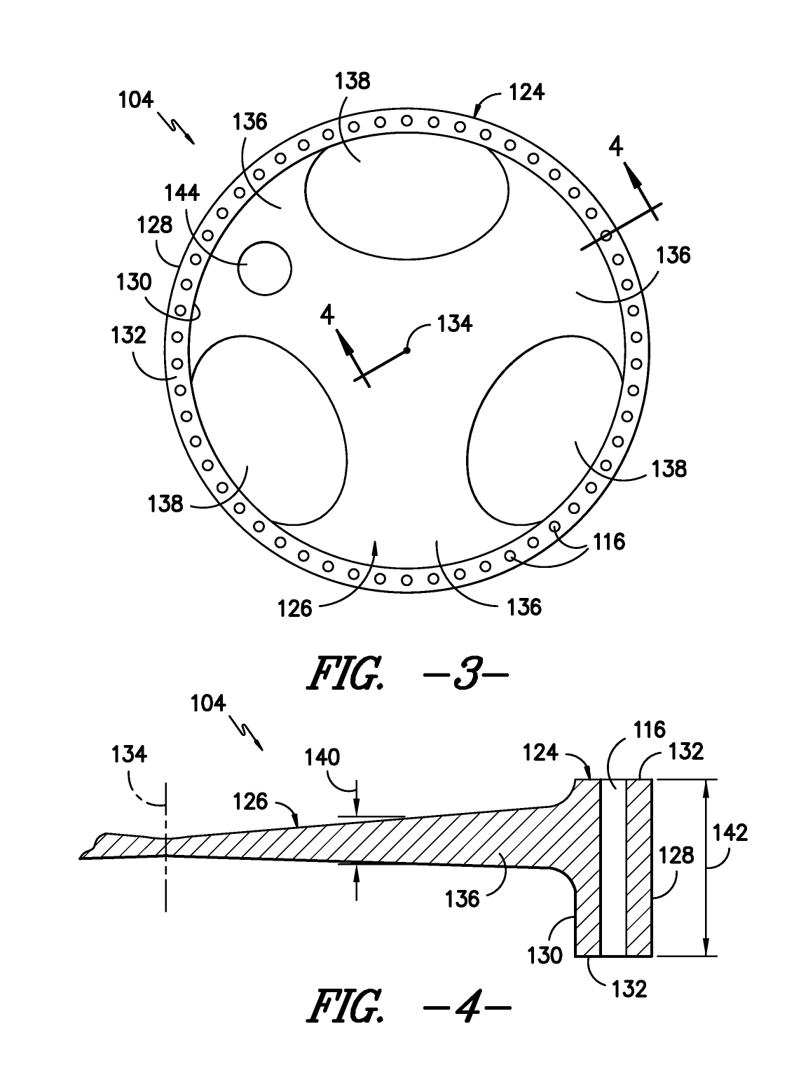

Referring now to FIGS. 2-4, several components of one embodiment of a hub assembly 100 are illustrated in accordance with aspects of the present subject matter. In particular, FIG. 2 illustrates a perspective, partially exploded view of the hub assembly 100. Additionally, FIG. 3 illustrates a front view of a stiffener plate 104 of the hub assembly 100 and FIG. 4 illustrates a cross-sectional view of the stiffener plate 104 shown in FIG. 3 taken about line 4-4.

As shown, the hub assembly 100 may generally include a hub 102, a plurality of stiffener plates 104 and a plurality of pitch bearings 106. In general, the hub 102 may be configured the same as or similar to any suitable hub known in the art (e.g., hub 18 shown in FIG. 1). Thus, in several embodiments, the hub 102 may comprise a hollow body configured for coupling the rotor blades 20 (FIG. 1) of the wind turbine 10 to a rotor shaft (not shown) of the turbine 10. As shown in FIG. 2, the hub 102 may generally extend between a first end 108 and a second end 110, with the first end 108 or the second end 110 being configured to receive and/or be coupled to the rotor shaft. In addition, the hub 102 may include a plurality of blade flanges 112 spaced apart around the outer perimeter of the hub 102. Each blade flange 112 may generally be configured to be coupled to one of the rotor blades 20 of the wind turbine 10 via one of the stiffener plates 104 and one of the pitch bearings 106 of the disclosed hub assembly 100. Thus, it should be appreciated that the number of blade flanges 112, stiffener plates 104 and pitch bearings 106 may generally correspond to the number of rotor blades 20 of the wind turbine 10. For instance, as shown in the illustrated embodiment, the hub assembly 100 includes three blade flanges 112, three stiffener plates 104 and three pitch bearings 106 for coupling three rotor blades 20 to the hub 102.

In general, each blade flange 112 may define a planar area for mounting each stiffener plate 104 and/or pitch bearing 106 to the hub 102. For example, as shown in FIG. 2, in one embodiment, each stiffener plate 104 may be configured to be mounted directly to one of the blade flanges 112, with the corresponding pitch bearing 106 being mounted to an opposing side of the stiffener plate 104. In alternative embodiments, each pitch bearing 106 may be configured to be mounted directly to one of the blade flanges 112, with the corresponding stiffener plate 104 being mounted to an opposing side of the pitch bearing 106.

It should be appreciated that the stiffener plates 104 and pitch bearings 106 may be configured to be coupled to the hub 102 using any suitable means known in the art. For example, as shown in FIG. 2, a plurality of studs or bolts 114 may be mounted within the hub 102 so as extend outwardly from each blade flange 112. In such an embodiment, each stiffener plate 104 and pitch bearing 106 may define a plurality of bolt openings 116 configured to receive the bolts 114. As such, by aligning the bolt openings 116 with the bolts 114, each stiffener plate 104 and pitch bearing 106 may be properly positioned relative to one of the blade flanges 112. One or more locking mechanisms 118 (e.g., washers and nuts) may then be installed onto each bolt 116 in order to secure the components together. Alternatively, the stiffener plates 104 and pitch bearings 106 may be configured to be coupled to the hub 102 using any other suitable means known in the art. For example, instead of using the same bolts 114 to connect both the stiffener plates 104 and the pitch bearings 106 to the hub 102, separate sets of bolts may be used to connect the stiffener plates 104 and pitch bearings 106 to the hub 102. In another embodiment, the stiffener plates 104 and/or the pitch bearings 106 may be configured to be welded to the hub 102. In a further embodiment, dowel pins, mechanical fits and/or male/female features may be used to couple the stiffener plates 104 and pitch bearings 106 to the hub 102.

It should also be appreciated that the pitch bearings 106 of the disclosed hub assembly 100 may generally be configured the same as or similar to any suitable pitch bearings known in the art. For example, as shown in FIG. 2, in one embodiment, each pitch bearing 106 may include an outer bearing race 120 and an inner bearing race 122, with the inner bearing race 122 being configured to rotate relative to the outer bearing race 124. As is generally understood, the outer bearing race 120 may be coupled to the blade flange 112 (or the stiffener plate 104) while the inner bearing race 122 may be coupled to the rotor blade 20. Thus, as the inner bearing race 122 is rotated relative to the fixed, outer bearing race 120, the rotor blade 20 may, in turn, be rotated about its longitudinal axis.

Referring still to FIGS. 2-4, each stiffener plate 104 may generally comprise a separate insert that is configured to be installed between the hub 102 and one of the rotor blades 20 (FIG. 1) of the wind turbine 10. For example, as indicated above, in one embodiment, each stiffener plate 104 may be positioned between the hub 102 and one of the pitch bearings 106. Alternatively, the pitch bearings 106 may be installed onto the hub 102 first, with the stiffener plates 104 being positioned between the pitch bearings 104 and the rotor blades 20.

In general, each stiffener plate 104 may include a mounting flange 124 and a stiffening web 126 extending radially within the mounting flange 124. As particularly shown in FIG. 2, the mounting flange 124 may generally comprise a cylindrically-shaped object having an outer surface 128 defining the outer perimeter of the flange 124 and an inner surface 130 defining the inner perimeter of the flange 124. In addition, the mounting flange 124 may also include opposed, planar surfaces 132 configured for positioning the stiffener plate 104 relative to the hub 102, one of the pitch bearings 106 and/or one of the rotor blades 20 of the wind turbine 10. For example, as shown in the embodiment of FIG. 2, when the stiffener plates 104 are installed onto the hub 102, the planar surfaces 132 of the stiffener plates 104 may be positioned flush against the blade flanges 112 and the outer bearing race 120 of each pitch bearing 106.

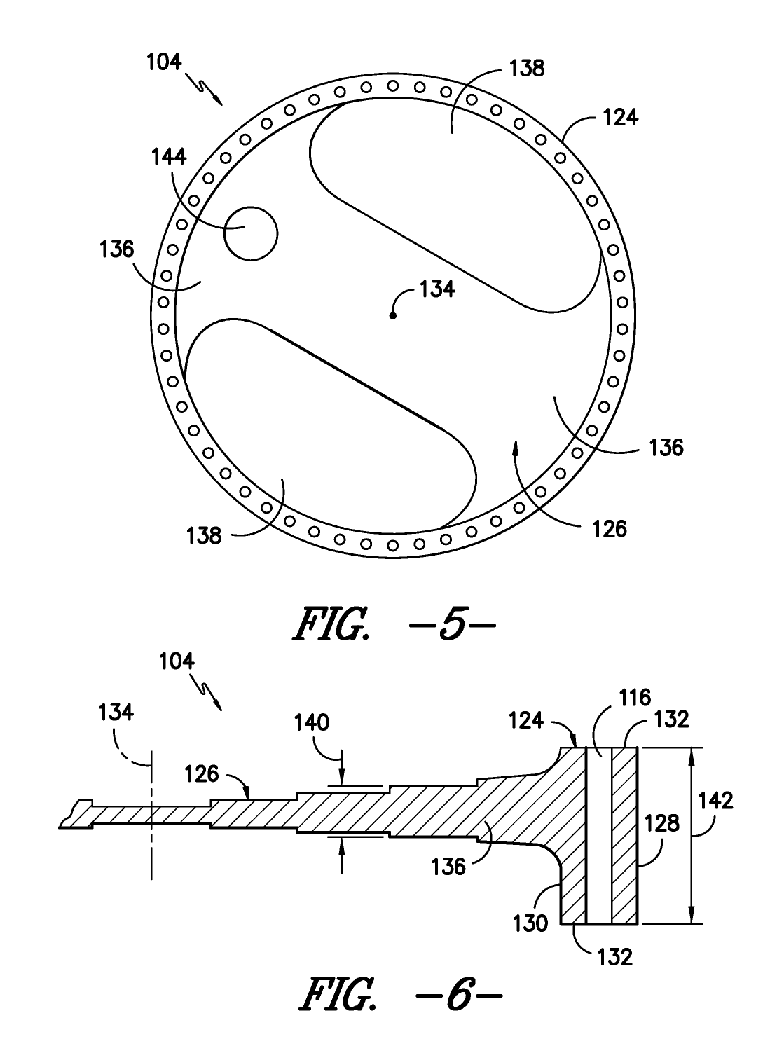

The stiffening web 126 of each stiffener plate 104 may generally be configured to extend radially inwardly from the inner perimeter of the mounting flange 124 towards a center point 134 of the stiffener plate 104 (also the center of the flange 124). As indicated above, the stiffening web 126 may be configured to increase the stiffness and rigidity of the hub assembly 100 by providing a structural, cross-member at the hub/blade interface. Thus, it should be appreciated that the stiffening web 126 may generally have any suitable configuration that permits the web 126 to function as described herein. For example, as shown in FIG. 3, in one embodiment, the stiffening web 126 may include three projections 136 extending outwardly from the mounting flange 124 and being integrally connected at the center point 134 of the stiffener plate 104, with each projection 136 being spaced apart equally around the circumference of the mounting flange 124 (e.g., by being spaced apart by 120 degrees). As such, three separate web openings 138 may be defined within the inner perimeter of the mounting flange 124. In another embodiment, as shown in FIG. 5, the stiffening web 126 may only include two projections 136 extending outwardly from the mounting flange 124, with the projections 136 being integrally connected at the center point 134. In such an embodiment, two web openings 138 may be defined within the inner perimeter of the mounting flange 124. Alternatively, the stiffening web 126 may have any other suitable configuration. For example, in a further embodiment, the stiffening web 126 may include four projections 136 extending outwardly from the mounting flange 124 towards the center point 134 that the stiffening web 126 defines an “X” or cross shape.

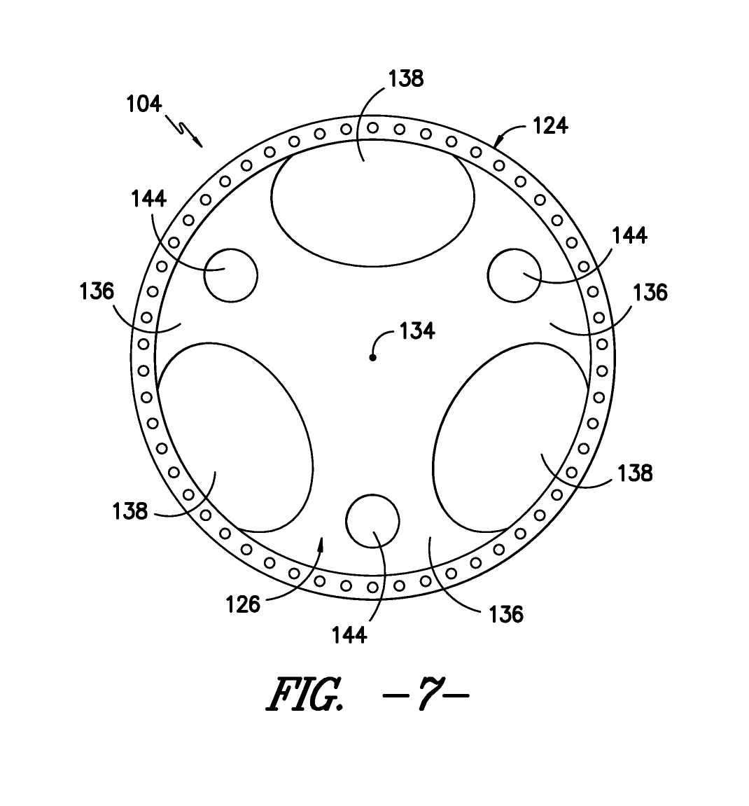

Additionally, in several embodiments, each stiffening web 126 may be configured to define a cross-sectional width 140 that varies between the inner perimeter of the mounting flange 124 and the center point 134 of the stiffener plate 104. For example, as shown in FIG. 4, in one embodiment, the cross-sectional width 140 of the stiffening web 126 may generally decrease as each projection 136 extends from the mounting flange 124 towards the center point 134. Specifically, as shown in the illustrated embodiment, the stiffening web 126 generally defines a tapered cross-sectional profile between the mounting flange 124 and the center point 134. As such, the maximum cross-sectional width 140 of the stiffening web 126 may be defined at the inner perimeter of the mounting flange 124, with the cross-sectional width continuously decreasing as each projection 136 extends towards the center point 134. Alternatively, the stiffening web 126 may be configured to define any other suitable cross-sectional profile that provides for a varying cross-sectional width between the mounting flange 124 and the center point 134. For example, as shown in FIG. 6, in another embodiment, the stiffening web 126 may define a stepped cross-sectional profile such that the cross-sectional width 140 is incrementally decreased between the mounting flange 124 and the center point 134.

By varying the cross-sectional width 140 of the stiffening web 126, numerous advantages may be obtained. For example, the varied cross-sectional width 140 may allow for the stiffness of the stiffening web 126 to be carefully tailored to match the stiffness needed for the particular hub on which the disclosed stiffener plate 104 is being installed. In addition, by reducing the cross-sectional width 140, the overall weight of the stiffening web 126 may be reduced.

It should be appreciated that the amount in which the cross-sectional width 140 of the stiffening web 126 is varied may generally depend on the configuration of the hub 102, the configuration of the stiffener plate 104 and/or the desired performance of the stiffener plate 104. However, in several embodiments, the ratio of the cross-sectional width 140 of the stiffening web 126 at the mounting flange 124 to the cross-sectional width 140 of the stiffening web 126 at the center point 134 may range from about 1:0.9 to about 1:0.2, such as from about 1:0.8 to about 1:0.25 or from about 1:0.6 to about 1:0.4.

It should also be appreciated that, in other embodiments, the cross-sectional width 140 of the stiffening web 126 may be configured to increase as each projection 136 extends outwardly from the mounting flange 124 towards the center point 134. For example, in one embodiment, the maximum cross-sectional width 140 of the stiffening web 126 may be defined at the center point 134, with the cross-sectional width 140 decreasing (e.g., continuously via a tapered profile or incrementally via a stepped profile) as the stiffening web 126 extends towards the mounting flange 124. However, in alternative embodiments, the stiffening web 126 may define a constant cross-sectional width 140.

Additionally, it should be appreciated that, in several embodiments, the mounting flange 124 may be configured to define a larger cross-sectional width than the stiffening web 124. For example, as shown in FIG. 4, the cross-sectional width 142 of the mounting flange 124 may be larger than the cross-sectional width 140 of the stiffening web 126 at the interface defined between such components. As a result, additional space may be provided around the inner perimeter of the mounting flange 124 for placing components and/or for performing maintenance operations.

Referring still to FIGS. 2-4, each stiffener plate 104 may also include a pitch drive opening 144 configured to receive at least a portion of a pitch drive 146 (FIG. 2) of the wind turbine 10. For example, as shown in FIG. 3, the pitch drive opening 144 may be defined in the stiffening web 126 at a location generally adjacent to the mounting flange 124. Thus, as shown in FIG. 2, a pinion gear 148 of the pitch drive 146 may be configured to extend through the pitch drive opening 144 so as to rotatably engage the inner bearing race 122 of the pitch bearing 106. Accordingly, as the pinion gear 148 is rotated (e.g., via a motor (not shown) of the pitch drive 146), the inner bearing race 122 may be rotated relative to the outer bearing race 120 of the pitch bearing 106.

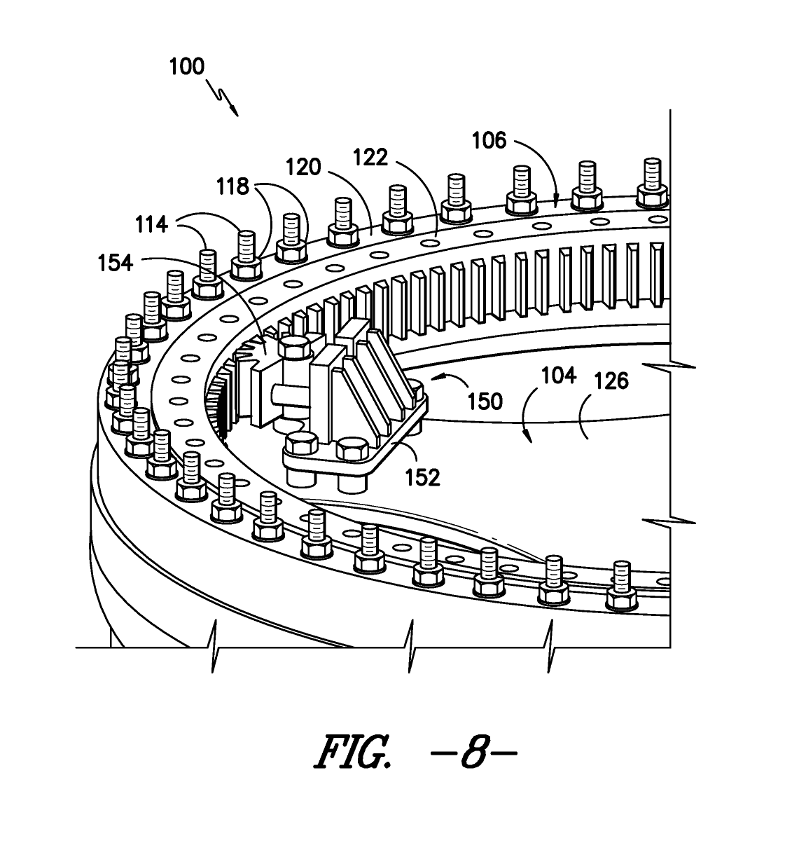

As an alternative to including a single pitch drive opening 144, the stiffener plate 104 may include a plurality of pitch drive openings 144 defined in the stiffening web 126. For example, as shown in FIG. 7, in one embodiment, three pitch drive openings 144 may be defined in the stiffening web 126. However, in alternative embodiments, any other suitable number of pitch drive openings 144 may be defined in the stiffening web 126, such as two pitch drive openings 144 or four or more pitch drive openings 144. Additionally, in several embodiments, the pitch drive openings 144 may be defined in the stiffening web 126 so as to be spaced equally apart around the circumference of the web 126. For instance, as shown in FIG. 7, the pitch drive openings 144 may be spaced apart circumferentially from one another by 120 degrees.

It should be appreciated that, by including a plurality of pitch drive openings 144 within each stiffening web 124, the location of each pitch drive 146 may be adjusted to accommodate additional components within the hub 102 and/or to facilitate maintenance operations. For instance, it may be desirable to relocate the pitch drive 146 to another pitch drive opening 144 in order to prevent significant wear from occurring along a particular circumferential portion of the inner bearing race 122. In addition, the plurality of pitch drive openings 144 may also allow for multiple pitch drives 146 to be used to rotate each pitch bearing 106, thereby providing for load sharing between the pitch drives 146. Moreover, by installing two or more pitch drives 144 onto each stiffening web 126, a back-up pitch drive 144 may be available in the event that one or more of the pitch drives 144 malfunctions.

Referring now to FIG. 8, in several embodiments, the stiffener plate 104 may also include a pitch locking device 150 configured to be mounted to the stiffening web 126. In general, the locking device 150 may be configured to lock the pitch bearing 106 by restricting the rotation of the inner bearing race 122 relative to the outer bearing race 120. Such locking of the pitch bearing 106 may generally be desirable, for example, to facilitate the quick and safe performance of maintenance operations (e.g., replacement of the pitch drives 144).

As shown in FIG. 8, the locking device 150 may generally include a base 152 configured to be mounted to the stiffening web 126 (e.g., using suitable mechanical fasteners) and a non-rotating lock gear 154 coupled to the base 152. In general, the lock gear 154 may be configured to engage the inner bearing race 122 of the pitch bearing 106. For example, as shown in FIG. 8, one or more of the teeth of the lock gear 154 may be configured to be engaged with one or more of the teeth of the inner bearing race 122. As such, the lock gear 154 may serve to prevent the inner bearing race 122 from rotating relative to the outer bearing race 120, thereby effectively locking the pitch bearing 106.

It should be appreciated that, in several embodiments, the base 152 of the locking device 150 may be configured to be permanently mounted to the stiffening web 126. In such an embodiment, the lock gear 154 may be installed onto the base 152 whenever it is desired to lock the pitch bearing 106. Alternatively, the entire locking device 150 may be configured to be installed and subsequently removed each time the pitch bearing 106 is locked.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stiffener plate for coupling a rotor blade to a hub of a wind turbine, the stiffener plate comprising:
a mounting flange configured to be coupled to at least one of the rotor blade or the hub, the mounting flange defining an inner perimeter and a center point;
a web extending from the inner perimeter towards the center point, the web defining a cross-sectional width,
wherein the cross-sectional width of the web varies between the inner perimeter and the center point.

2. The stiffener plate of claim 1, wherein the cross-sectional width decreases as the web extends from the inner perimeter towards the center point.

3. The stiffener plate of claim 2, wherein a ratio of the cross-sectional width of the web at the inner perimeter to the cross-sectional width of the web at the center point ranges from about 1:0.9 to about 1:0.2

4. The stiffener plate of claim 1, wherein the cross-sectional width increases as the web extends from the inner perimeter towards the center point.

5. The stiffener plate of claim 1, wherein the web defines a tapered cross-sectional profile between the inner perimeter and the center point.

6. The stiffener plate of claim 1, wherein the web defines a stepped cross-sectional profile between the inner perimeter and the center point.

7. The stiffener plate of claim 1, wherein the mounting flange defines a cross-sectional width, the cross-sectional width of the web being less than the cross-sectional width of the mounting flange at the inner perimeter.

8. The stiffener plate of claim 1, wherein a plurality of pitch drive openings are defined in the stiffener, each of the plurality of pitch drive openings being configured to receive at least a portion of a pitch drive of the wind turbine.

9. The stiffener plate of claim 1, further comprising a locking device coupled to the web, the locking device being configured to engage a pitch bearing of the wind turbine.

10. A stiffener plate for coupling a rotor blade to a hub of a wind turbine, the stiffener plate comprising:
a mounting flange configured to be coupled to at least one of the rotor blade or the hub, the mounting flange defining an inner perimeter and a center point;
a web extending from the inner perimeter towards the center point, the web defining a plurality of pitch drive openings,
wherein each of the plurality of pitch drive openings is configured to receive at least a portion of a pitch drive of the wind turbine.

11. The stiffener plate of claim 10, wherein three pitch drive openings are defined in the stiffener, the pitch drive openings being spaced apart from one another by 120 degrees.

12. The stiffener plate of claim 10, wherein the web defines a cross-sectional width, the cross-sectional width of the web varying between the inner perimeter and the center point.

13. The stiffener plate of claim 12, wherein the web defines a tapered cross-sectional profile between the inner perimeter and the center point.

14. The stiffener plate of claim 12, wherein the web defines a stepped cross-sectional profile between the inner perimeter and the center point.

15. A wind turbine, comprising:
a rotor including a hub and at least one rotor blade extending outwardly from the hub;
a pitch bearing coupled between the hub and the at least one rotor blade; and
a stiffener plant comprising:
a mounting flange configured to be coupled between the pitch bearing and the hub or between the pitch bearing and the at least one rotor blade, the mounting flange defining an inner perimeter and a center point;
a web extending from the inner perimeter towards the center point; and
a locking device mounted to the wen, the locking device being configured to engage the pitch bearing.

16. The wind turbine of claim 15, wherein the locking device comprises a lock gear, the lock gear being configured to be engaged against an inner bearing race of the pitch bearing.

17. The wind turbine of claim 15, wherein a plurality of pitch drive openings are defined in the web, each of the plurality of pitch drive openings being configured to receive at least a portion of a pitch drive of the wind turbine.

18. The wind turbine of claim 15, wherein the web defines a cross-sectional width, the cross-sectional width of the web varying between the inner perimeter and the center point.

19. The wind turbine of claim 18, wherein the web defines a tapered cross-sectional profile between the inner perimeter and the center point.

20. The wind turbine of claim 18, wherein the web defines a stepped cross-sectional profile between the inner perimeter and the center point.
